(19) United States
(12) Patent Application Publication
(10) Pub. No.: US 2026/0015259 A1
(43) Pub. Date: Jan. 15, 2026

(54) DESALINATING DISSOLVED GAS FLOATATION SYSTEMS

(71) Applicant: Badwater Alchemy Inc., Seattle, WA (US)

(72) Inventors: Andrew F. Mason, Seattle, WA (US); William J. Walker, Seattle, WA (US); Ozgur Emek Yildirim, Bellevue, WA (US)

(21) Appl. No.: 19/267,332

(22) Filed: Jul. 11, 2025

Related U.S. Application Data
(60) Provisional application No. 63/670,511, filed on Jul. 12, 2024.

(51) Int. Cl. C02F 1/24; C02F 1/52; C02F 1/74; C02F 103/08

(52) U.S. Cl. CPC C02F 1/24; C02F 1/5245; C02F 1/74; C02F 2103/08

(57) ABSTRACT

An example method includes generating a mixture by injecting a desalination media into an aqueous solution including water one or more solutes. Salt-media aggregates are generated when particles in the desalination media capture the one or more solutes. The example method further includes generating bubbles in the mixture by injecting a gas into the mixture; generating a blanket on a surface of the mixture by carrying, by the bubbles, the salt-media aggregates to the surface of the mixture; and removing the blanket from the mixture.

### CROSS-REFERENCE TO RELATED APPLICATION

This application claims priority to U.S. Provisional App. No. 63/670,511, which was filed on Jul. 12, 2024 and is incorporated by reference herein in its entirety.

### BACKGROUND

Freshwater is essential for agricultural, industrial, and domestic uses. According to the United Nations (UN), about half of the world's population experiences severe freshwater scarcity every year (UN World Water Development Report, 19 Mar. 2024). An increase in freshwater demand from trends of population growth and socio-economic development may further exacerbate this problem.

Freshwater can be produced by desalinating brackish water and seawater, which is more readily available than existing freshwater. Desalination is increasingly important for producing drinking water and irrigation water in arid climates. For example, a majority of drinking water in Israel is now produced using desalination. In the United States (US), desalination plants in some areas already produce a significant amount of municipal drinking water. Many existing desalination plants utilize reverse osmosis (RO) for water desalination. However, RO and many other previous desalination technologies (e.g., distillation, ion exchange, electrodialysis, etc.) have several drawbacks that prevent widespread use. For instance, many of these techniques utilize significant energy expenditures during operation. Other costs, as well as reliability concerns, associated with these techniques limit their widespread use.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates desalinating dissolved gas floatation (DGF) system in accordance with various implementations of the present disclosure.

FIG. 2 illustrates an example environment for controlling a desalination system, such as the desalinating DGF system described with reference to FIG. 1.

FIG. 3 illustrates an example of a tank-based desalination media system, which can be incorporated into a desalinating DGF system.

FIG. 4 illustrates an example environment in which a particle captures a sodium ion (Na+) and a chloride ion (Cl−).

FIG. 5 illustrates an example process for removing salt from water using DGF.

FIG. 6 illustrates at least one example device configured to enable and/or perform various functionality discussed herein.

### DETAILED DESCRIPTION

Various systems, devices, and methods described herein relate to techniques for removing solutes from water, such as sodium ions, chloride ions, magnesium ions, and other dissolved salts. According to various examples, techniques described herein can remove solutes from water with minimal energy expenditures and costs. In some implementations, additional particles, materials, or contaminants can be removed from water using various techniques described herein.

In various cases, a mixture is generated by introducing a liquid desalination media containing metal particles to an aqueous solution of solutes. In particular cases, the particles include iron (e.g., zero-valent iron (ZVI)). In some examples, the particles include at least one of copper, aluminum, or zinc. In some examples, metal atoms within the particles are configured to oxidize, such as in the presence of water and/or an additional oxidizing gas (e.g., air) that is injected into the mixture. For instance, one or more species of metal oxyhydroxides are generated in the particles. In various cases, electrostatic forces of atoms within the particles attracts the solutes to the particles, thereby capturing the solutes from the mixture. For instance, the captured solutes and particles may aggregate into salt-media aggregates within the mixture.

According to various implementations, the salt-media aggregates can be removed from the mixture using a dissolved gas floatation (DGF) system. For instance, gas bubbles are introduced into the mixture. The gas bubbles carry the salt-media aggregates (and optionally other contaminants within the solution, such as hydrocarbons, particles, algae, etc.) to a surface of the solution, thereby forming a “blanket” on the surface of the mixture. The blanket can be removed from the mixture by a skimmer or other mechanical device. In some cases, additional salt-media aggregates may sink to the bottom of the mixture, and can be collected and removed using a settling tank. Accordingly, the salt-media aggregates can be efficiently removed from the mixture, leaving behind desalinated water without the metal particles of the liquid desalination media.

When the salt-media aggregates are removed from the mixture, the resultant water has a significantly lower concentration of the solutes than the original aqueous solution prior to treatment. In some cases, the water is further treated using an RO device. Seawater, saline, brine, and other types of aqueous solutions can be treated using various implementations described herein, in order to yield treated water that may be suitable for irrigation uses and/or for human consumption.

In various implementations of the present disclosure, techniques can be utilized to remove at least 75% of an amount of one or more solutes (e.g., salt) from the aqueous solution. In some cases, at least 80% of the solute(s) can be removed from the aqueous solution. The efficiency of the process can be impacted by the amount of solute(s) in the original aqueous solution, the amount of particles in the desalination media, the amount of metal in the desalination media relative to the volume of the aqueous solution, the amount of time the particles are present in a mixture with the aqueous solution prior to particle removal, the amount of oxidizing gas introduced into the mixture, the pH of the mixture, features of a desalination system that facilitates the desalination process, and other characteristics of implementations of the process described herein.

Various implementations of the present disclosure will now be described with reference to the accompanying figures.

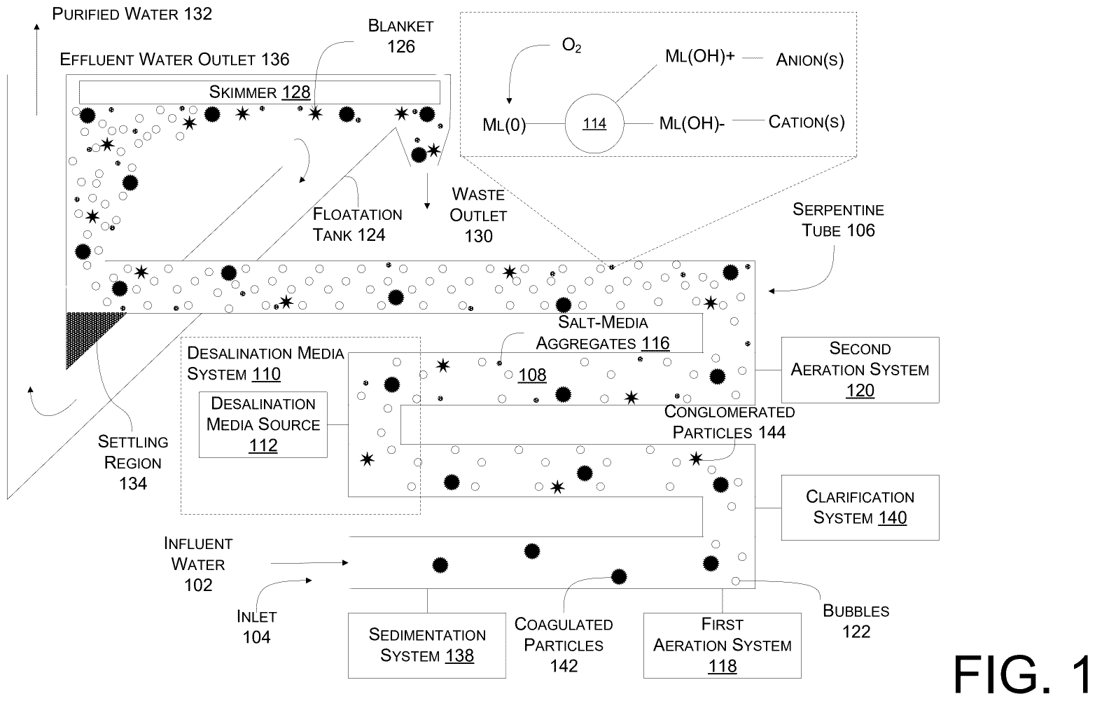

FIG. 1 illustrates desalinating DGF system 100 in accordance with various implementations of the present disclosure. The desalinating DGF system 100 receives influent water 102 at an inlet 104. The influent water 102, for instance, includes one or more contaminants. In various cases, the influent water 102 is a solution including one or more solutes. For instance, the influent water 102 may include saline water. As used herein, the terms “saline,” “saline water,” and their equivalents, may refer to an aqueous solution including dissolved salts, metals, solids, other contaminants, or any combination thereof at greater than a threshold concentration (e.g., greater than 3% salinity). In some cases, other types of aqueous solutions including other dissolved solutes can be substituted for the saline water. In various cases, saline water is unfit for human and/or animal consumption. In some cases, saline water is unfit for a water supply for plants, such as in an agricultural context. In various examples, saline may include seawater, industrial waste, mining waste, agricultural waste, produced water (e.g., a byproduct of ground oil and/or gas extraction), flowback (e.g., water injected and returned during a hydraulic fracturing process), or any combination thereof. In some examples, saline water includes brine. As used herein, the term “brine,” and its equivalents, may refer to an aqueous solution having greater than 5% salinity.

In various implementations, the solute(s) in the influent water 102 include one or more metals, such as at least one of copper, zinc, magnesium, manganese, aluminum, selenium, or one or more radionuclides. In some cases, the solute(s) include dissolved ions, such as at least one of magnesium, sodium, chloride, phosphate, sulfate, arsenic, nitrate, nitrite, or hypochlorite.

In particular cases, the solute(s) in their aqueous form are charged. For example, at least some of the solute(s) may have a positive charge (e.g., cations). Examples of solutes having a positive charge include, for instance, sodium ions (Na+), copper ions (Cu2+), zinc ions (Zn2+), magnesium ions (Mg2+), manganese ions (Mn2+), aluminum ions (Al3+), or arsenic ions (As5+). Further, at least some of the solute(s) may have a negative charge (e.g., anions). Examples of solutes having a negative charge include, for instance, chloride ions (Cl−), selenium ions (Sn2−), phosphate ions (PO₄3−), sulfate ions (SO₄2−), nitrate ions (NO₃−), nitrite ions (NO−), or hypochlorite ions (ClO−).

In some examples, the influent water 102 contains additional contaminant materials. In some cases, the influent water 102 includes one or more hydrocarbons, such as organic compounds containing alkane groups, alkene groups, alkynes, aromatic groups (e.g., phenyl groups), and the like. Specific examples of hydrocarbons include alkanes, paraffins, aliphatic saturated compounds, polycyclic aromatic hydrocarbons, ethylbenzene, m-xylene, o-xylene, p-xylene, hydrocarbon oils, tar, gasoline, diesel fuel, or the like. In various examples, the influent water includes one or more cells, such as archaea, bacteria, algae, yeast, protozoa, and the like. In various implementations, the influent water 102 may have a nonzero total dissolved solid (TDS), such as a TDS in a range of about 10,000 parts-per-million (ppm) to about 100,000 ppm. The contaminant materials in the influent water 102, for instance, prevent the use of the influent water 102 for agricultural or drinking water uses.

In various cases, the influent water 102 enters a fluid circuit that includes a serpentine tube 106. The serpentine tube 106 includes multiple channels connected by multiple turns, that cause mixing of the influent water 102 with one or more components added to the influent water 102 in the fluid circuit. In various implementations, a mixture 108 including the influent water 102 is formed within the fluid circuit.

Various components are injected into the mixture 108 within the serpentine tube 106. In various implementations, a desalination media system 110 is configured to introduce a desalination media into the mixture 108. For instance, the desalination media system 110 includes a desalination media source 112 that is configured to store desalination media for release into the mixture 108. For instance, the desalination media source 112 may include a tank that is configured to store the desalination media in a fluid form. In some examples, the desalination media system 110 further includes one or more valves and/or one or more pumps configured to selectively release the desalination media into the serpentine tube 106.

The desalination media, in various cases, includes a fluid (e.g., a slurry) containing particles 114. For example, the particles 114 include copper, aluminum, magnesium, manganese, zinc, iron, or any combination thereof. In some cases the particles 114 include an alloy of multiple metals. In some examples, the particles 114 include at least one oxidized metal. For instance, the particles 114 include one or more metal oxyhydroxides (e.g., iron oxyhydroxide). In some cases, the particles 114 may include a network structure of atoms (e.g., metal atoms and/or any combination of metal atoms, hydrogen atoms, and oxygen atoms) that are bonded to each other. The network structure may be cubic, tetragonal, or the like.

The desalination media, for instance, includes a mixture of water and the particles 114. According to various cases, a concentration of the particles 114 in the desalination media is in a range of 0.1 grams per liter (g/L) to 100 g/L, such as in a range of 1 g/L to 50 g/L or a range of 10 g/L to 25 g/L.

According to various cases, the particles 114 include one or more metals in a zero valency state, such as zero-valent iron (ZVI). As used herein, the term “Zero Valent Iron (ZVI),” “zerovalent iron,” “nonvalent iron,” “Fe(0),” and their equivalents, can refer to one or more iron atoms with a valency of zero. In some cases, iron can change between a zerovalent state and a multivalent state, such as the bivalent Fe2+ form or trivalent Fe3+ form.

When metal atoms on the surface of the particles 114 become oxidized, the atoms may be converted into multivalent metal atoms. As used herein, the term “oxidation,” and its equivalents, can refer to a chemical reaction in which at least one atom loses electrons. As used herein, the term “reduction,” and its equivalents, can refer to a chemical reaction in which at least one atom gains electrons. In a “reduction-oxidation” or “redox” reaction, electrons are transferred from one chemical species (e.g., a species undergoing oxidation) to another chemical species (e.g., a species undergoing reduction). For example, ZVI can be oxidized when it reacts with an oxidizing species (e.g., oxygen gas, ozone, etc.) to form other valency states, such as Fe(II) and/or Fe(III). In particular cases, the particles 114 include an oxyhydroxide, such as Fe(III) oxyhydroxide, (FeO(OH)).

When one or more metals in the particles 114 are converted into a multivalent state, such as through the process of oxidation, the resultant material may include charged atoms. For instance, oxygen atoms in the oxyhydroxide(s) of the particles 114 may be negatively charged, whereas hydrogen atoms in the oxyhydroxide(s) of the particles 114 may be positively charged. In various cases, the electrical charges of various atoms within the particles 114 is dependent on the pH of the bulk solution. The positive and negative charges of various atoms within the particles 114 causes the particles 114 to electrostatically attract charged solutes in the vicinity of the particles 114. For instance, negatively charged solutes, or anions, (e.g., chloride ions) in the mixture 108 may be electrostatically attracted to positively charged atoms (e.g., hydrogen atoms) in the particles 114. Further, positively charged solutes (e.g., sodium ions), or cations, in the mixture 108 may be electrostatically attracted to negatively charged atoms (e.g., oxygen atoms) in the particles 114. Further, in some instances, the charged solutes may become covalently bonded to each other and/or to metals on the surface of the particles. Accordingly, the charged solutes in the mixture 108 may be adsorbed onto the surfaces of the particles 114. In various cases, the particles 114 are configured to remove dissolved salts, such as dissolved sodium chloride, from the mixture 108. Accordingly, the particles 114 may be utilized to at least partially desalinate the influent water 102.

In some cases, the desalination media includes additional materials. In various cases, the desalination media is generated as a mixture of metal salts and a reducing agent. Examples of the metal salts include, for instance, metal chlorides (e.g., iron chloride), metal nitrates (e.g., iron nitrate), metal sulfates (e.g., iron sulfate), or other types of metal salts. Examples of the reducing agent, in various cases, include uric acid, urea, tartaric acid, maleic acid, or tannic acid. According to various examples, the desalination media may be acidic. For instance, the desalination media may have a pH in a range of 2 to 7, such as a pH in a range of 2.5 to 5.0. In some implementations, the desalination media may be configured to be stored for an extended period of time (e.g., days, weeks, months, or years), and may include one or more materials configured to prevent or minimize bacterial growth within the desalination media during storage. In some cases, the desalination media is stored in a kit (e.g., including a polymer-enclosed package that prevents contamination during storage).

In various examples, the particles 114 within the desalination media include nanoparticles. As used herein, the term “nanoparticle,” and its equivalents, can refer to a solid particle that is shorter than 100 nanometers (nm) in at least one dimension. In some cases, a nanoparticle can have a diameter of less than 100 nm. As used herein, a “size,” “length,” “diameter,” or their equivalents of a particle may refer to a Z-average diameter (e.g., as determined using Dynamic Light Scattering (DLS)). In some cases, a “size,” “length,” “diameter,” or their equivalents, of multiple particles may refer to a Z-average diameter in which the particles have a weighted differential size distribution within +10% of the Z-average diameter. In various implementations described herein, the particles 114 may, for instance, may be assumed to have spherical shapes, such that a Z-average diameter of the particles 114 (e.g., generated using DLS) in suspension may be between 1 and 100 nm. In some cases, the nanoparticles among the particles 114 may have a Z-average diameter that is between 40 to 60 nm, such as about 50 nm. In some implementations, at least 90% of a (volume or intensity) weighted differential size distribution of the particles 114 in solution (e.g., generated using DLS) may be between 20 and 80 nm, such as 50 nm. In some cases, the length of the particle 114 can be defined by microscope measurements (e.g., via at least one optical microscope, an electron microscope, a scanning probe microscope, or the like), settling velocities (e.g., by applying Stokes' law to a measured velocity of the particle), and/or sedimentation methods.

According to various implementations, the desalination media source 112 outputs an amount of desalination media into the fluid circuit (e.g., to form the mixture 108) that is dependent characteristics of the influent water 102 input into the fluid circuit. For instance, a ratio of a mass of the particles 114 to a volume of the influent water 102 that has entered the fluid circuit is in a range of 0.01 g/L to 1.0 g/L, such as in a range of 0.04 g/L to 0.50 g/L. In some cases, the amount of the desalination media introduced into the fluid circuit is dependent on a salinity of the influent water 102. In various cases, the salinity of the influent water 102 is represented in units of electrical conductance, such as millisiemens per centimeter (mS/cm) or mS per meter (mS/m). In some examples, the salinity of the influent water 102 is measured by inserting electrodes into the influent water 102, applying a voltage between the electrodes, measuring a current between the electrodes, and calculating the electrical conductance based on the voltage and the current. In various implementations, a ratio of a mass of the particles 114 added to the fluid circuit to a salinity of the influent water 102 and/or mixture 108 is in a range of 0.1 g/(mS/cm) to 0.5 g/(mS/cm) or 0.1 g/(mS/m) to 0.5 g/(mS/m).

In various implementations, the particles 114 are configured to remove dissolved salt from the mixture 108 by forming salt-media aggregates 116. The salt-medial aggregates 116 include one or more of the particles 114 and captured salt. In various cases, the salt-media aggregates 116 are formed during a dwell time of the desalination media and/or the particles 114 within the fluid circuit. In various implementations, the dwell time (also referred to as a “retention time”) of the mixture 108 in the fluid circuit is in a range of five minutes to 1 hour. Experimentally, it has been determined that the efficacy of salt removal within the fluid circuit is dependent on the pH of the mixture 108. In various implementations, a buffer source (not illustrated) is further configured to inject a buffer solution into the fluid circuit (e.g., into the serpentine tube 106) that adjusts the PH of the mixture 108. The buffer solution, in various cases, includes an aqueous solution that has a basic pH. For example, the buffer solution includes a hydroxide (e.g., calcium hydroxide and/or magnesium hydroxide) and/or a bicarbonate (e.g., calcium bicarbonate and/or magnesium bicarbonate). For instance, the buffer source may inject the buffer solution into the mixture 108 such that the mixture 108 has a pH in a range of 7.5 to 12.0.

The particles 114 are configured to efficiently capture the salt within the influent water 102 through the formation of the salt-media aggregates 116. However, it may be further advantageous to desalinate the influent water 102 by removing the salt-media aggregates 116 from the mixture 108. For instance, the mixture 108 containing the salt-media aggregates 116 may be unsuitable for drinking water or agricultural uses, but removal of the salt-media aggregates 116 can leave the remaining portions of the mixture 108 suitable for these uses.

In various implementations of the present disclosure, the desalinating DGF system 100 is further configured to remove the salt-media aggregates 116 from the mixture 108. The desalinating DGF system 100 includes a first aeration system 118 and/or a second aeration system 120 configured to generate bubbles 122 within the mixture 108. For instance, the first aeration system 118 may include a gas tank and one or more valves configured to release a gas contained in the tank into the mixture 108. In some implementations, the bubbles 122 include microbubbles and/or nanobubbles. The second aeration system 120 may have a similar structure to the first aeration system 118, for instance. Optionally, the gas in the bubbles 122, in various cases, includes an oxidizing gas that enhances the oxidation reaction of at least one the metal in the particles 114 (e.g., the formation of at least one oxyhydroxide). The gas, for example, includes at least one of air, oxygen, ozone, or carbon monoxide. In some cases, the gas includes additional gases to prevent explosions, fires, and other risks when the desalinating DGF system 100 is operating. For instance, the gas may include nitrogen gas. In some examples, the gas includes air. In various cases, the gas is in the bubbles 122 retains a substantially anoxic environment within the mixture 108. For instance, the gas in the bubbles 122 may omit an oxidizing gas, and may include nitrogen and/or carbon dioxide.

In various implementations, the bubbles 122 are mixed into the mixture 108 by flowing through the serpentine tube 106 with the mixture 108. In various cases, the bubbles 122 adhere to various contaminant materials suspended within the mixture 108. For instance, the bubbles 122 adhere to the salt-media aggregates 116 in the mixture. Optionally, an additional floatation material is added to the fluid circuit to enhance floatation of the salt-media aggregates 116. Examples of floatation materials include xanthates, pine oil, fatty acids, and the like.

In particular examples, the second aeration system 120 is configured to output the bubbles 122 into the serpentine tube 106 at a location that is downstream of the desalination media system 110. The term “downstream,” and its equivalents, may refer to a location along a fluid circuit that receives flow from (e.g., has a lower fluid pressure than) an “upstream” location along the fluid circuit. In various cases, the direction of flow through the serpentine tube 106 causes the mixture 108 including the desalination media output by the desalination media source 112 to flow to a location at which the second aeration system 120 injects at least a portion of the bubbles 122. In the example of FIG. 1, the first aeration system 118 injects the bubbles 122 at a location in the serpentine tube 106 that is upstream of the desalination media system 110. In some cases, the first aeration system 118 or the second aeration system 120 can be omitted.

The fluid circuit further includes a floatation tank 124 that is configured to receive the mixture 108 from the serpentine tube 105. The bubbles 122 are configured to carry the contaminant materials (including the salt-media aggregates 116) in the mixture 108 to a surface of the mixture 108 in the floatation tank 124. For instance, the bubbles 122, even attached to the contaminant materials, may float to the surface of the mixture 108 within the floatation tank 124.

The collected contaminant materials form a blanket 126 on the surface of the mixture 108 in the floatation tank 124. In various implementations, a skimmer 128 is configured to siphon the blanket 126 to a waste outlet 130 of the floatation tank 124. In some implementations, the skimmer 128 includes one or more blades configured to move the blanket 126 toward the waste outlet 130. In various cases, the blade(s) are attached to a motor that selectively moves the blade(s) along the surface of the mixture 108 in the floatation tank 124. In some cases, the motor causes the blade(s) to move at a rate that results in minimal turbulence within the floatation tank 124 and/or ensure that a thickness of the blanket 126 is lower than a threshold thickness (e.g., 15 centimeters (cm).

The waste outlet 130 releases the contaminant materials within the blanket 126 from the floatation tank 124, thereby separating purified water 132 from the mixture 108. In various cases, because at least a portion of the salt-media aggregates 116 are collected in the blanket 126 and released from the waste outlet 130, the purified water 132 includes desalinated water. That is, the purified water 132 includes a portion of the influent water 102 that omits the solute(s) and/or one or more additional contaminants.

The salt-media aggregates 116 may further be removed from the mixture 108 by additional mechanisms. For instance, the mixture 108 may enter a portion of the floatation tank 124 that includes a settling region 134. Due to a buoyancy of a portion of the salt-media aggregates 116 that are not adhered to the bubbles 122, these salt-media aggregates 116 may spontaneously sink and be collected in the settling region 134. In some examples, the settling region 134 is fluidically coupled with a release valve at a base of the settling region 134 (not illustrated), such that the salt-media aggregates 116 collected in the settling region 134 can be removed from the floatation tank 124.

According to various implementations, the efficiency of the desalinating DGF system 100 can be further enhanced by the inclusion of a sedimentation system 138 and/or a clarification system 140. The sedimentation system 138 and/or the clarification system 140 are configured to release additional materials into the fluid circuit that further enhance capture of contaminant material(s) in the mixture 108 by the bubbles 122. For instance, the sedimentation system 138 and/or the clarification system 140 are configured to release the additional materials into the serpentine tube 106.

The sedimentation system 138 may be configured to release one or more coagulants into the serpentine tube 106. Examples of coagulants include calcium oxide (also referred to as “lime”), aluminum sulfate (also referred to as “alum”), ferric chloride, polyaluminum chloride (PAC), ferric sulfate, sodium aluminate, or a combination thereof. The coagulants, in various cases, cause the one or more contaminant materials in the mixture 108 to coagulate into coagulated particles 142. In some examples, the salt-media aggregates 116 are included in the coagulated particles 142. Other contaminant materials in the coagulated particles 142 may include silica, suspended solids, and the like.

The clarification system 140 is configured to release one or more flocculants into the serpentine tube 106. Examples of flocculants include polymers (e.g., polyacrylamide, anionic polymers, cationic polymers, etc.), starches, chitosan, or any combination thereof. The flocculants, in various cases, cause one or more of the contaminant materials in the mixture 108 to conglomerate into conglomerated particles 144. In some examples, the salt-media aggregates 116 and/or the coagulated particles 142 are included in the conglomerated particles 144. Other contaminant materials may also be included in the conglomerated particles 144.

In various cases, the bubbles 122 are configured to adhere to the coagulated particles 142 and/or the conglomerated particles 144. Further, the bubbles 122 may be configured to carry the coagulated particles 142 and/or the conglomerated particles 144 into the blanket 126 for removal from the mixture 108. In various implementations, the coagulated particles 142 and conglomerated particles 144 include salt (e.g., within the salt-media aggregates 116) as well as additional contaminant materials, thereby enabling the desalinating DGF system 100 to remove multiple contaminants from the influent water 102.

In various implementations, the purified water 132 flows through the floatation tank 124 and is released from an effluent water outlet 136. Optionally, the effluent water outlet 136 is fluidically coupled with the inlet 104 for at least a portion of time, such that the effluent water outlet 136 is recycled through the desalinating DGF system 100. Accordingly, a level of contaminant material(s) within the purified water 132 can be further reduced.

In some cases, one or more processors control the components of the desalinating DGF system 100 in response to conditions within the desalinating DGF system and/or the influent water 102. In some cases, one or more sensors (not illustrated) are disposed within the fluid circuit, communicatively coupled with the processor(s), and configured to detect at least one parameter of the desalinating DGF system 100. Examples of sensors include temperature sensors, salinity sensors, pH sensors, pressure sensors, light sensors, and the like. Examples of parameters detected by the sensors include, for instance, temperature, salinity, pH, pressure, light absorbance, light transmittance, and the like. The processor(s), for instance, may selectively activate components of the desalinating DGF system 100 based on one or more parameters detected by the sensor(s). According to various cases, the processor(s) may activate or deactivate an example component in response to detecting that a parameter is above a first threshold or below a second threshold.

Although not specifically illustrated in FIG. 1, additional structures may be added to the desalinating DGF system 100. It has been observed that the temperature of the mixture 108 impacts the speed of the desalination process implemented by the desalinating DGF system 100. In some examples, the desalinating DGF system 100 includes one or more heaters (not illustrated) that increase a temperature of the mixture 108 above a lower threshold of 10, 15, 20, 25, or 30 degrees Celsius (° C.) (and below a boiling temperature), such as a temperature in a range of 17° C. to 35° C. In some cases, the desalinating DGF system 100 operates in an environment in which an ambient temperature is greater than 20, 25, or 30° C., such that the heater(s) may be unnecessary and/or deactivated.

In various implementations, the purified water 132 has significantly less dissolved salt than the influent water 102. For instance, the purified water 132 omits at least 75% of the salt originally included in the influent water 102. In some cases, the purified water 132 omits at least 80%, 85%, or 90% of the salt originally included in the influent water 102. In various implementations, a salinity of (e.g., dissolved sodium ions and chloride ions) the purified water 132 is less than 25% (or less than 20%) of the salinity of the influent water 102.

In some cases, however, at least a portion of the dissolved salt from the influent water 102 is retained in the purified water 132. This portion of the dissolved salt may prevent the purified water 132 from being suitable for drinking water and/or agricultural uses. In various cases, the purified water 132 may have a salinity that is greater than or equal to 5.0 mS/cm, 4.0 mS/cm, 3.0 mS/cm, 2.0 mS/cm, 1.0 mS/cm, 0.7 mS/cm, 0.5 mS/cm, 0.1 mS/cm, or 0.0 mS/cm.

In various cases, a reverse osmosis (RO) device (not illustrated) is configured to substantially remove the remaining portion of the dissolved salt from the purified water 132. In various cases, the RO device includes a membrane that divides a first space and a second space. The membrane is semipermeable, such that water can pass through the membrane but ions (e.g., sodium and/or chloride ions) and particles cannot move through the membrane. In some cases, the membrane includes cellulose acetate, polyamide, or any combination thereof. The purified water 132, in some cases, is introduced into the first space. In various implementations, the RO device actively induces greater than a threshold pressure within the first space. For instance, the RO device includes a pump or other pressure-inducing device configured to induce a pressure of at least 2 bar, 5 bar, 10 bar, 20 bar, 40 bar, 60 bar, 80 bar, or 85 bar. As a result of the pressure in the first space, water within the first space flows through the membrane and is output as further purified water. The further purified water, for instance, is permeate of the RO device. In various implementations, the further purified water has a salinity in a range of 0.0 mS/cm to 5.0 mS/cm or 0.0 mS/cm to 0.5 mS/cm. Thus, the further purified water may be suitable for irrigation, human consumption, or animal consumption. In some cases, the further purified water is suitable as drinking water.

In various cases, the desalinating DGF system 100 is a hybrid system that has various advantages over systems that exclusively use RO to remove solutes from water. In one example advantage over a pure RO system, the purified water 132 can be produced and treated with significantly less energy expenditure using the desalinating DGF system 100. In various cases, the fluid circuit within the desalinating DGF system 100 can be operated in a substantially passive fashion, wherein the mixture 108 is substantially propelled through the fluid circuit using gravitational force. In some cases, one or more pumps (not illustrated) are also included to increase the flow of the mixture 108 through the fluid circuit. However, the energy utilized by the pump(s) may nevertheless be significantly lower than energy that would be utilized by a pump in a hypothetical RO system configured to purify the influent water 102 directly.

Second, waste produced by the hybrid desalinating DGF system 100 is more easily managed than waste produced by a pure RO system. A hypothetical pure RO system would produce highly concentrated brine as a result of extracting permeate from the influent water 102, for instance. The salinity of the brine could be harmful to the environment if discharged without utilizing specialized disposal methods (e.g., deep-well injection) that can be costly and difficult. In contrast, the waste media output from the waste outlet 130 and/or the settling region 134 produced by the hybrid desalinating DGF system 100 can be easily converted to solid salt, which can be disposed of more easily than brine. In various cases, the particles 114 within the waste media can additionally be recycled through the desalinating DGF system 100 (e.g., by recycling through the desalination media source 112). Moreover, concentrated water produced by the operation of the RO device can be recycled back through the desalination system 100. For instance, the concentrated water can be discharged back into the fluid circuit of the desalinating DGF system 100 (e.g., into the influent water 102) in order to remove additional salt from the concentrated water into the waste media output from the waste outlet 130 and/or settling region 134.

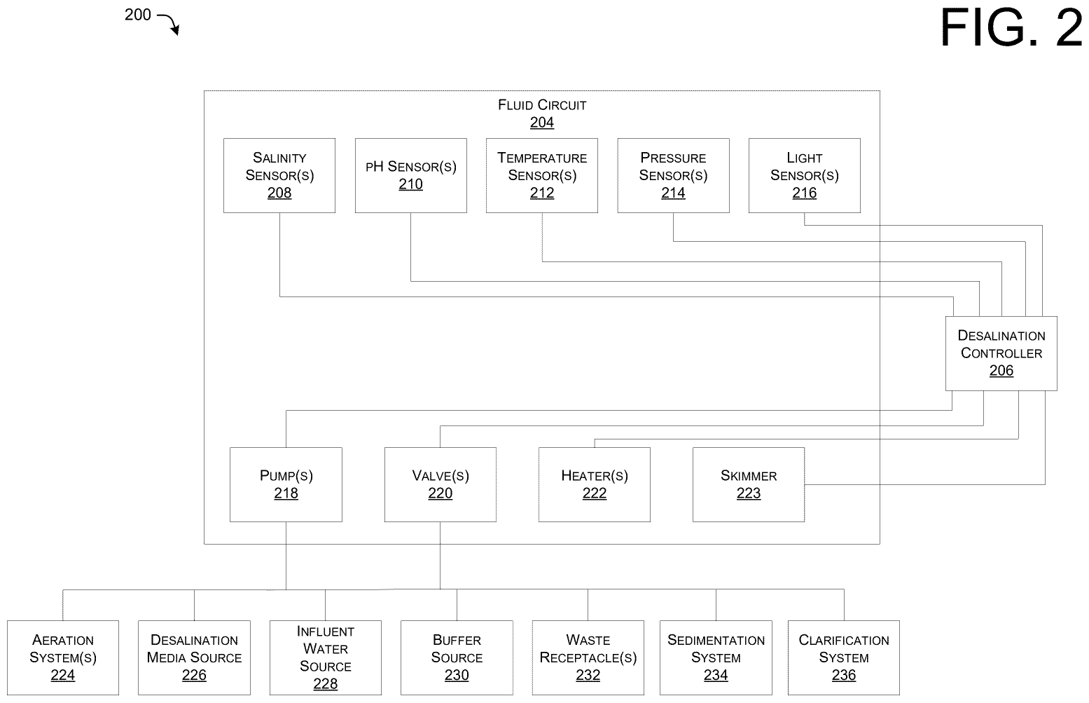

FIG. 2 illustrates an example environment 200 for controlling a desalination system, such as the desalinating DGF system 100 described above with reference to FIG. 1. The environment 200 includes a fluid circuit 204. The fluid circuit 204 may include one or more tanks (e.g., within the desalination media system 110, the floatation tank 124, etc.) and/or one or more tubes (e.g., the serpentine tube 106) . . . . In some cases, the fluid circuit 204 includes one or more pipes, tubes, or other structures that accommodate fluid flow. A fluid, such as water (with or without dissolved solutes), a desalination media, a gas (e.g., air, oxygen, nitrogen, etc.), or any combination thereof, can be disposed in the fluid circuit 204. In some cases, the fluid flows through the fluid circuit 204. Although not specifically illustrated, in some cases, the fluid circuit 204 includes one or more inlets and/or one or more outlets.

In various implementations of the present disclosure, a desalination controller 206 is configured to analyze and/or cause modifications to conditions within the fluid circuit 204. In various cases, the desalination controller 206 is configured to optimize the conditions in the fluid circuit 204 to enhance efficient removal of one or more solutes from water disposed in the fluid circuit 204. The desalination controller 206 can be embodied in software and/or hardware. For example, the desalination controller 206 includes at least one computing device, such as a server computer, a laptop, a tablet computer, a smart phone, or other type of computer. In various cases, the desalination controller 206 includes one or more processors configured to execute instructions. The instructions, for instance, are stored in memory and/or non-transitory computer-readable media. By executing the instructions, the desalination controller 206 performs various functions described herein.

In some cases, the desalination controller 206 is located on the premises of the environment 200. For instance, the desalination controller 206 could be packaged with the fluid circuit 204. In some cases, the desalination controller 206 is located remotely from the premises of the desalination system. For instance, the desalination controller 206, in some cases, is implemented in at least one server computer located at least one kilometer (km) away from the fluid circuit 204.

Various sensors may be communicatively coupled to the desalination controller 206. As used herein, endpoints are “communicatively coupled,” if they are connected to one another via at least one wired (e.g., electrical, optical, etc.) interface and/or at least one wireless interface (e.g., BLUETOOTH™, cellular, near-field communication (NFC), etc.) over which communication signals can be transmitted between the endpoints. These sensors, in various cases, are configured to detect one or more parameters of the fluid circuit 204. These parameters include at least one of salinity, pH, temperature, pressure, light transmittance, or light reflectance, for example.

At least one salinity sensor 208, for instance, is disposed within the fluid circuit 204. The salinity sensor(s) 208 is configured to detect a salinity level of water in one or more locations within the fluid circuit 204. Examples of the salinity sensor(s) 208 include, for instance, an electrical sensor configured to detect an electrical conductivity of the fluid in the fluid circuit 204. In various cases, the salinity sensor(s) 208 includes an anode and a cathode that are suspended in the fluid, as well as a power source that applies a voltage across the anode and the cathode. In some examples, the salinity sensor(s) 208 detects the electrical conductivity of the fluid by detecting an electrical current between the anode and the cathode. Alternatively, the salinity sensor(s) 208 includes a current source that outputs a current across the anode and the cathode, and then a voltage detector that detects the voltage between the anode and the cathode in order to detect the electrical conductivity of the fluid. In various implementations, the electrical conductivity is proportional to an amount of dissolved solute(s) in the fluid.

At least one pH sensor 210 is disposed in the fluid circuit 204, for example. The pH sensor(s) 210 is configured to detect a pH of the fluid at one or more positions in the fluid circuit 204. In some cases, the pH sensor(s) 210 include a pH electrode bulb including a membrane (e.g., including glass) that is permeable to H+ ions in the fluid. The pH sensor(s) 210 may further include a reference cell that contains a PH neutral electrolyte solution. An electrical sensor is connected to the pH electrode bulb and the reference cell and is configured to detect a voltage between the pH electrode bulb and the reference cell. If H+ ions in the fluid enter the pH electrode bulb, then a voltage is detected by the electrical sensor. The magnitude of the voltage, for instance, is dependent on an amount of H+ ions in the fluid, and is therefore indicative of the acidity of the fluid.

At least one temperature sensor 212 may be disposed in the fluid circuit 204. The temperature sensor(s) 212 is configured to detect the temperature of the fluid circuit 204 at one or more positions within the fluid circuit 204. Various types of temperature sensors can be utilized in the environment 200. According to various implementations, the temperature sensor(s) 212 include one or more thermocouples, thermistors, Peltier elements, or any combination thereof. In various examples, the temperature sensor(s) 212 is configured to output an electrical signal indicative of one or more detected temperatures by the temperature sensor(s) 212.

In some cases, one or more pressure sensor(s) 214 are disposed in the fluid circuit 204. The pressure sensor(s) 214 is configured to detect a pressure at one or more positions within the fluid circuit 204. In some cases, the pressure sensor(s) 214 include one or more capacitive and/or piezoelectric pressure sensors. For example, the pressure sensor(s) 214 include a membrane disposed between a space with a reference pressure and a space within the fluid circuit 204. When the pressure in the space within the fluid circuit 204 is different than the reference pressure, the membrane is configured to deform. In various implementations, the pressure sensor(s) 214 detects the pressure in the space based on an amount of deformation of the membrane. For instance, the capacitance of a capacitor including the membrane as a plate, or an electrical signal output by the membrane (e.g., due to the piezoelectric effect), is indicative of the deformation of the membrane and the pressure in the space.

According to some examples, one or more light sensors 216 are disposed in the fluid circuit 204. In some cases, the light sensor(s) 216 include one or more light sources (e.g., light-emitting diodes (LEDs)) and one or more light detectors (e.g., photodiodes, phototransistors, etc.) configured to detect light emitted by the light source(s). In some cases, the fluid in the fluid circuit 204 is physically disposed between the light source(s) and the light detector(s). An amount of light detected by the light detector(s), for example, is dependent on an amount of the light that is transmitted (e.g., not absorbed) by the fluid in the fluid circuit 204. In some examples, the light detector(s) is configured to detect an amount of light that is both emitted by the light source(s) and reflected by the fluid in the fluid circuit 204. In some cases, a frequency of the light emitted by the light source(s) and detected by the light detector(s) is optimized for absorbance and/or reflectance of a particular material (e.g., oxidized particles) in the fluid disposed in the fluid circuit 204. For example, the absorbance of the light of an aqueous solution of the oxidized nanoparticles at a predetermined concentration may be greater than a predetermined threshold. In various cases, the light detector(s) output an electrical signal indicative of an amount of light absorbed and/or reflected by the fluid in the fluid circuit 204. This signal may be indicative of an amount of the material present in the fluid in the fluid circuit 204.

The desalination controller 206, in various cases, receives signals from the salinity sensor(s) 208, the pH sensor(s) 210, the temperature sensor(s) 212, the pressure sensor(s) 214, the light sensor(s) 216, or any combination thereof, that are indicative of parameters detected by the respective sensors. In some cases, the signals include one or more analog signals, and the desalination controller 206 includes one or more analog-to-digital converters (ADCs) configured to convert the signals into digital signals indicative of the detected parameters. In some cases, the signals output by the sensors include digital signals that are indicative of the detected parameters. In various cases, the desalination controller 206 is configured to analyze data (e.g., in the form of digital signals) indicative of the detected parameters.

In various implementations, the desalination controller 206 is communicatively coupled to one or more active elements that are configured to change conditions within the fluid circuit 204. The desalination controller 206, for instance, is configured to output one or more signals (also referred to as “control signals”) to the active elements in order to cause changes to conditions within the fluid circuit 204.

In various cases, one or more pumps 218 are present in the fluid circuit 204. The pump(s) 218, in various cases, are configured to control pressure differentials between different subspaces in the fluid circuit 204, thereby inducing fluid flow within the fluid circuit 204. The pump(s) 218, for instance, include at least one peristaltic pump, at least one centrifugal pump, at least one diaphragm pump, at least one magnetic pump, or any combination thereof. In some cases, the pump(s) 218 can include one or more propellers configured to cause fluid movement within the fluid circuit 204.

According to some implementations, one or more valves 220 are present in the fluid circuit 204. The valve(s) 220, for instance, are configured to selectively open or close portions of the fluid circuit 204 to fluid flow. In various cases, the valve(s) 220 include check valves, ball valves, butterfly valves, or any combination thereof. Notably, the valve(s) 220 may include at least one valve configured to control liquid (e.g., saline and/or desalination media slurry) flow in the fluid circuit 204 and/or to control gas (e.g., air) flow in the fluid circuit 204.

In various cases, one or more heaters 222 are present in the fluid circuit. The heater(s) 222, for instance, are configured to heat portions of the fluid circuit 204. In some cases, the heater(s) 222 include one or more resistive elements that output heat when a voltage is applied. In some cases, the heater(s) 222 include one or more Peltier elements.

In various implementations, a skimmer 223 is present in the fluid circuit 204. For instance, the skimmer 223 includes a motor configured to move one or more blades along a surface of the fluid in the fluid circuit 204. According to various examples, the skimmer 223 is configured to move a blanket (e.g., a sludge blanket) on the surface of the fluid toward a waste outlet.

In some examples, the pump(s) 218 and/or valve(s) 220 are configured to control the flow of fluid between the fluid circuit 204 and one or more external spaces (e.g., receptacles). These external spaces may include one or more aeration systems 224 (e.g., the first aeration system 118 and/or the second aeration system 120), a desalination media source 226 (e.g., the desalination media source 112), an influent water source 228 (e.g., a source of the influent water 102), a buffer source 230, one or more waste receptacles 232, a sedimentation system 234 (e.g., the sedimentation system 138), and a clarification system (e.g., the clarification system 140). In various cases, the aeration system(s) 224 include at least one space that contains a gas (e.g., air, oxygen, nitrogen, or the like). The desalination media source 226, for instance, is a space that contains desalination media (e.g., a slurry including particles configured to bind to solutes in the influent water). In some examples, the influent water source 228 includes influent (e.g., saline) water that is to be desalinated by the desalination system. In various cases, the buffer source 230 is a space that includes a buffer solution (e.g., a bicarbonate solution) that can be used to adjust the pH within the fluid circuit 204. In various examples, the waste receptacle(s) 232 includes a space that is configured to receive waste media and/or captured solute(s) from the fluid in the fluid circuit 204. The sedimentation system 234 may include a space that is configured to store one or more coagulants. The clarification system 236 may include a space that is configured to store one or more flocculants. These external spaces, for instance, include one or more tanks, tubs, or other containers that are fluidly and selectively coupled to the fluid circuit 204.

In various implementations of the present disclosure, the desalination controller 206 is configured to control the pump(s) 218, the valve(s) 220, the heater(s) 222, or any combination thereof, based on one or more parameters detected by the salinity sensor(s) 208, the pH sensor(s) 210, the temperature sensor(s) 212, the pressure sensor(s) 214, the light sensor(s) 216, or any combination thereof. For example, the desalination controller 206 may output a control signal that activates or deactivates the pump(s) 218, the valve(s) 220, the heater(s) 222, the skimmer 223, or any combination thereof, in response to determining that one or more parameters are above a first threshold and/or below a second threshold.

In particular cases, the desalination controller 206 controls the pump(s) 218 and/or the valve(s) 220 in response to detecting that a salinity detected by the salinity sensor(s) 208 is above a threshold. In some examples, the desalination controller 206 causes the pump(s) 218 to recirculate fluid in the fluid circuit 204 until the salinity is below the threshold. In some examples, the desalination controller 206 causes the valve(s) 220 to block the fluid from being discharged (e.g., into a filter or into a settling tank) until the salinity is above the threshold. In some cases, the desalination controller 206 causes the pump(s) 218 and/or valve(s) 220 to release desalination media from the desalination media source 226 in response to detecting that the salinity is above the threshold. In some examples, the desalination controller 206 causes the pump(s) 218 and/or valve(s) 220 to release saline water from the influent water source 228 into the fluid circuit 204 in response to detecting that the salinity is below the threshold.

According to some cases, the desalination controller 206 controls conditions within the fluid circuit 204 based on a pH detected by the pH sensor(s) 210. In some examples, the desalination media has a relatively low pH (e.g., due to the presence of phenols added to the desalination media during particle synthesis). It has been observed that the efficiency and speed by which the desalination media removes solute(s) from saline can be enhanced by lowering the pH of the saline added to the fluid circuit 204. In some examples, the desalination controller 206 causes the pump(s) 218 and/or valve(s) 220 to release buffer (e.g., water containing bicarbonate or some other type of basic solution) from the buffer source 230 into the fluid circuit 204 in response to detecting that the pH detected by the pH sensor(s) 210 is below a threshold.

In some examples, the desalination controller 206 adjusts conditions within the fluid circuit 204 based on a temperature detected by the temperature sensor(s) 212. In various implementations, it has been observed that the efficiency and speed by which the desalination media removes solute(s) from saline can be enhanced by controlling the temperature of the fluid in the fluid circuit 204 to be in a range of 25° C. to 50° C. In various cases, the desalination controller 206 causes the heater(s) 222 to activate in response to determining that a temperature detected by the temperature sensor(s) 212 is below a threshold.

In various instances, the desalination controller 206 adjusts the conditions within the fluid circuit 204 based on a pressure detected by the pressure sensor(s) 214. A pressure differential between different locations along the fluid circuit 204 may be indicative of an amount of fluid flow in the fluid circuit 204. In some cases, an initial phase of flow through the fluid circuit 204 is achieved via hydrostatic flow from the influent water source 228 into the fluid circuit 204, wherein the influent water source 228 may be elevated with respect to the fluid circuit 204. However, after a sufficient amount of saline water has left the influent water source 228, in some cases, pressure in the fluid circuit 204 may equilibrate, causing limited to nonexistent fluid flow. In some examples, the desalination controller 206 activates the pump(s) 218 to activate in response to determining that a difference between a pressure detected at a first part of the fluid circuit 204 and a pressure detected at a second part of the fluid circuit 204 is below a threshold.

According to some cases, the desalination controller 206 may cause the valve(s) 220 to selectively vent gasses in the fluid circuit 204 to an environment outside of the fluid circuit 204. For instance, if the fluid circuit 204 is sealed from an external environment, and the aeration system(s) 224 release gas into the fluid circuit 204, the pressure within the fluid circuit 204 may build to an undesirable level. In various cases, the desalination controller 206 causes the valve(s) 220 to vent fluid in the fluid circuit 204 to the external environment in response to detecting that a pressure detected by the pressure sensor(s) 214 is above a threshold.

In some examples, the desalination controller 206 selectively causes removal of waste media and/or solute from fluid in the fluid circuit 204. In particular examples, particles capture solute from the fluid during oxidation. The oxidation of particles in the fluid, in various cases, changes the absorbance and/or reflectance of the fluid. For instance, oxidized nanoparticles can cause treated water to appear opaque and/or as an orange color. In various cases, the desalination controller 206 causes the pump(s) 218 and/or valve(s) 220 to release waste media and solute from the fluid circuit 204, or to activate the skimmer 223 to release waste media and solute from the fluid circuit 204, and into the waste receptacle(s) 232 in response to determining that a light absorbance and/or reflectance of the fluid in the fluid circuit 204 exceeds a first threshold and/or that a light transmittance of the fluid in the fluid circuit 204 is below a second threshold. The desalination controller 206, in various implementations, determines the light absorbance, reflectance, or transmittance based on signals output by the light sensor(s) 216.

An RO device (not illustrated) may be configured to receive treated water from the fluid circuit 204. In some implementations, the desalination controller 206 further controls the pump(s) 218 to induce greater than a threshold pressure on a side of a membrane of the RO device, which may cause the RO device to generate purified water by removing an additional amount of solute(s) from the treated water. In various cases, the desalination controller 206 is further configured to cause the pump(s) 218 to move brine from the side of the membrane of the RO device to fluid circuit 204 and/or the influent water source 228.

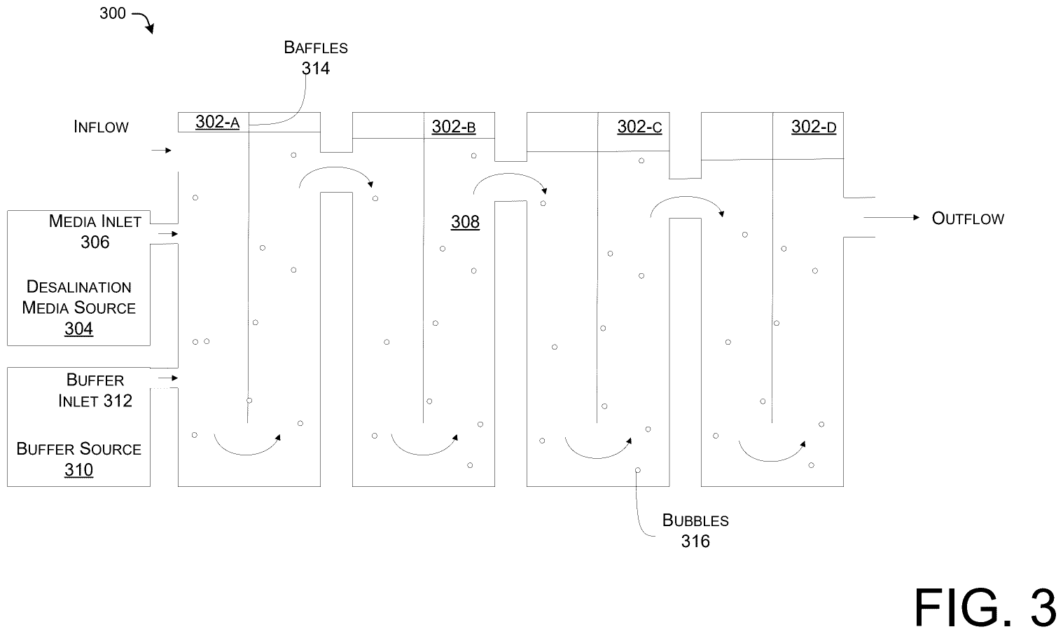

FIG. 3 illustrates an example of a tank-based desalination media system 300, which can be incorporated into a desalinating DGF system. For example, the desalination media system 300 of FIG. 3 can be substituted for the desalination media system 110 described with reference to FIG. 1.

In various implementations, the desalination media system 300 includes multiple tanks 302-a to 302-d that are fluidically connected to each other in series. For instance, inflow to the desalination media system 300 is received at a first tank 302-a, which is fluidly coupled to a fluid circuit containing influent water and/or other fluid mixtures. For instance, the first tank 302-a may receive the inflow from at least a portion of a serpentine tube. In the example illustrated in FIG. 2, an inlet of the first tank 302-a extends through a sidewall of the first tank 302-a. The sidewall extends from a base of the first tank 302-a. The sidewall may be parallel to a first direction and the base may be parallel to a second direction, wherein the first direction crosses the second direction. During operation of the desalination media system 300, the first direction may be opposite of a direction of gravity. In some cases, the sidewall is perpendicular to the base. In some examples, the base has a polygonal (e.g., rectangular) and/or circular shape. A lid may be removably coupled to the sidewall. The sidewall, base, and lid include one or more materials configured to contain water, such as saline water. In some examples, the sidewall and base include a metal (e.g., stainless steel), a polymer (e.g., polyethylene), glass, or any combination thereof.

In various implementations, a desalination media source 304 outputs a desalination media into the first desalination tank 302-a via a media inlet 306, thereby forming a mixture 308 of the inflow and the desalination media. In the example illustrated in FIG. 3, the media inlet 306 extends through the sidewall of the first desalination tank 302-a. However, in some cases, the media inlet 306 extends through the lid of the first desalination tank 302-a. The desalination media is configured to capture one or more solutes in the inflow.

Optionally, the desalination media system 300 further includes a buffer source 310 that outputs a buffer into the first desalination tank 302-a via a buffer inlet 312. In various implementations, the buffer is used to control a pH of the mixture 308, such as to optimize a reaction between the desalination media and one or more solutes in the inflow. In various cases, the desalination media is acidic, but the reaction between particles in the desalination media and the solute(s) in the inflow is optimized at a basic pH. For instance, the pH of the mixture 308 is in a range of 7.5 to 12.0. Optionally, the buffer source 310 outputs the buffer to the mixture 308 in order to achieve the basic pH within the mixture 308. For instance, the buffer includes a hydroxide (calcium hydroxide and/or magnesium hydroxide) and/or bicarbonate.

The mixture 308 of the inflow and the desalination media travel through a fluid circuit including an interior space of the first desalination tank 302-a. In various cases, the fluid circuit further includes the interior of a second desalination tank 302-b, a third desalination tank 302-c, and a fourth desalination tank 302-d. The first to fourth desalination tanks 302-a to 302-d are connected to one another in series, such that the mixture 308 travels through the first desalination tank 302-a, then the second desalination tank 302-b, then the third desalination tank 302-c, then the fourth desalination tank 302-d.

In various implementations, the first to fourth desalination tanks 302-a to 302-d each include baffles 314. The baffles 3014 extend parallel to the first direction within the interior of each of the first to fourth desalination tanks 302-a to 302-d. In various implementations, an example baffle 314 extends from the lid of the corresponding desalination tank among the first to fourth desalination tanks 302-a to 302-d. Each baffle 314 is spaced apart from the base of the corresponding desalination tank. In some cases, the baffles 314 may be coupled to a floatation device that floats on the surface of the mixture 308 and extends in a direction opposite to the first direction into the mixture 308. In some cases, at least some of the baffles 314 are configured to extend from the base of the corresponding desalination tank among the first to fourth desalination tanks 302-a to 302-d and are spaced apart from the lid and/or an upper surface of the mixture 308. Due to the spacings between the baffles 314 and the walls of the desalination tanks 302-a to 302-d, the fluid circuit within the interior of the desalination tanks 302-a to 302-d may have a winding path through the desalination media system 300. In some cases, the baffles 314 enhance turbulence and/or mixing within the mixture 308 when the mixture 308 is moving through the fluid circuit. In some cases, the turbulence enhances the efficiency of the reaction between the solute(s) in the inflow and the particles in the desalination media.

In various cases, a gas is introduced into the mixture 308. For instance, a gas source may inject the gas through gas inlets within the base of each desalination tank among the desalination tanks 302-a to 302-d. In some implementations, the bubbles 316 are part of the inflow to the desalination media system 300. The gas, for instance, propagates through the mixture 308 in the form of bubbles 316. The bubbles 316 travel through the mixture 108 in the fluidic circuit. The gas, for instance, may include an oxidizing gas (e.g., air, oxygen, etc.) or an inert gas (e.g., nitrogen). In some examples, the bubbles 316 move countercurrent to the mixture 308. In some cases, the bubbles 316 enhance mixing within the mixture 308.

In various implementations, after traversing the desalination tanks 302-a to 302-d, the mixture 308 exits the desalination media system 300 as outflow. In some implementations, the outflow is directed to at least a portion of a serpentine tube (e.g., the serpentine tube 106). In some cases, the outflow is directed to a floatation tank (e.g., the floatation tank 124). According to various implementations, the desalination media system 300 is incorporated into a desalinating DGF system.

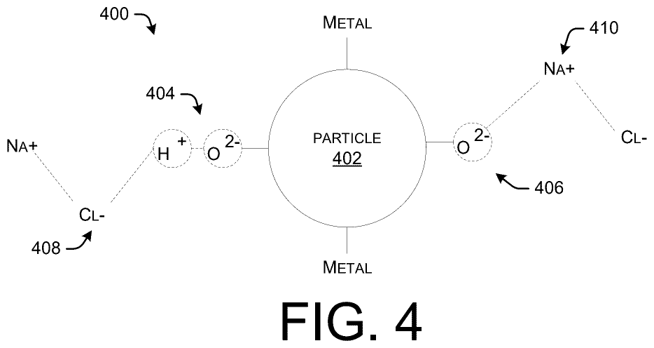

FIG. 4 illustrates an example environment 400 in which a particle 402 captures a sodium ion (Na+) 410 and a chloride ion (Cl−) 408. Although FIG. 4 is described with reference to removing sodium and chloride ions, it should be understood that in some cases, other positive and negative ions can be removed from water using similar techniques.

In various implementations, the particle 402 is a nanoparticle. According to various implementations, the particle 402 may have a width that is less than 1,000 nm. In some cases, a length (e.g., a diameter) of the particle 402 may be between 10 and 100 nm, 20 to 80 nm, or 45 to 55 nm. In various implementations, the particle 402 may have a surface area between 0.1 square meters per gram (m2/g) to 25 m2/g. The particle 402 may include at least one metal, such as at least one of copper, aluminum, magnesium, manganese, zinc, or iron (e.g., ZVI or Fe(0)). In some cases, the particle 402 includes at least one zero valent metal (ZVM).

In some cases, when metal atoms in the particle 402 begins to oxidize in the presence of water, the metal atoms on the surface of the particle 402 is converted into at least one metal oxyhydroxide (e.g., metal-O(OH)). For instance, hydroxyl (—OH) groups 404 are bound to the surface of the particle 402. In various cases, oxygens 406 are additionally exposed on the surface of the particle 402 when hydrogens from at least a portion of the hydroxyl groups 404 are removed from the hydroxyl groups 404. For instance, the hydrogens may spontaneously be removed from the hydroxyl groups 404 based on a pH of a solution in which the particle 402 is present. In various cases, the pH of the solution is optimized to produce a mixture of hydroxyl groups 404 and oxygens 406 exposed on the surface of the particle 402. In various cases, the hydroxyl groups 404 electrostatically attract negatively charged ions and/or solutes within the solution, such as Cl− 408. In some implementations, the oxygens 406 electrostatically attract positively charged ions and/or solutes within the solution, such as Na+ 410.

In particular cases, the particle 402 includes ZVI. When ZVI, for instance becomes oxidized, two types of complexes may be formed: FeOOH2+ (e.g., including the hydroxyl groups 404) and FeOOH− (e.g., including the oxygens 406). The positively charged FeOOH2+ may electrostatically attract the negatively charged Cl− 408 dissolved in the water. The negatively charged FeOOH− may electrostatically attract the positively charged Na+ 410 dissolved in the water. The electrostatic attraction between the charged complexes and the Cl− 408 and Na+ 410 ions may cause a first layer of Cl− 408 and Na+ 410 ions to be adsorbed onto the surface of the particle 402.

According to various cases, once a first layer of Na+ 410 and Cl− 408 is adsorbed onto the surface of the particle 402, additional ions may be further adsorbed onto the first layer. For instance, additional negatively charged Cl− 408 may be electrostatically attracted to the positively charged Na+ 410 in the first layer, and additional positively charged Na+ 410 may be electrostatically attracted to the negatively charged Cl− 408 in the first layer. Multiple layers of Cl− 408 and Na+ 410 may assemble on the surface of the particle 402. In some cases, the Cl− 408 and Na+ 410 may form a crystal structure.

The adsorption of the Na+ 410 and Cl− 408 due to electrostatic forces with oxidized forms of the metal in the particle 402 may occur relatively quickly. As Cl− 408 is attracted to, and attaches to, Fe(OH) 4+ (for example), functional groups on the surface of the particle 402, a subsequent, slower reaction may take place that also causes desalination. In some examples, the Cl− 408 may further catalyze the oxidation of other metal atoms (e.g., other ZVM atoms, such as Fe(0)) in the particle 402. Additional Cl− 408 may diffuse through the surface layer of the particle 402 and cause further oxidation of the metal atoms below the outer surface of the particle 402 and within the interior of the particle 402. Additional layers of metal-O—H—Cl and metal-O—Na may be generated within the interior of the particle 402.

Both reactions (the surface adsorption and capture by metal within the interior of the particle 402) may cause water uptake. In addition, when the particle 402 is submerged in water, the salinity gradient may increase as a distance to the particle 402 decreases, due to the capture of the Na+ 410 and the Cl− 408. Accordingly, in some cases, a desalination media including the particle 402 may aggregate into solid particles that expand in size, due to water uptake and osmosis, when exposed to saline water.

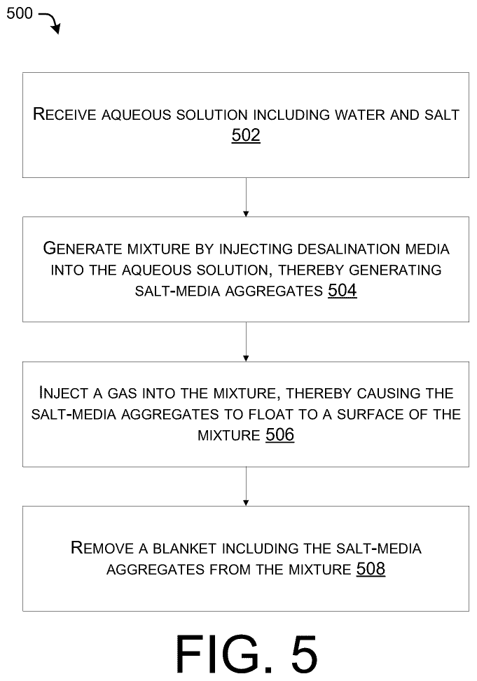

FIG. 5 illustrates an example process 500 for removing salt from water using DGF. The process 500 is performed by an entity, such as a desalination system (e.g., the desalinating DGF system 100), at least one processor, a computing device, a controller (e.g., the desalination controller 206), a desalination environment (e.g., the environment 200), or any combination thereof.

At 502, the entity receives an aqueous solution including water and salt. For example, the aqueous solution includes saline, seawater, brine, produced water, flowback, or any combination thereof. In some cases, the salt includes sodium and/or chloride. In various cases, the salt includes halite, magnesium sulfate, potassium bicarbonate, calcium chloride, calcium sulfate, or any combination thereof. In some examples, the salt includes magnesium, sulfate, potassium, carbonate, calcium, or any combination thereof. According to various examples, the aqueous solution as a pH in a range of 7.5 to 12. In some implementations, the aqueous solution further includes one or more additional contaminants, such as at least one hydrocarbon, at least one cell, or another type of contaminant.

At 404, the entity generates a mixture by injecting desalination media into the aqueous solution, thereby generating salt-media aggregates. In some cases, the desalination media includes particles configured to bind to solutes in the aqueous solution. For instance, the desalination media may be a slurry. The particles, in some examples, include nanoparticles. In various cases, the particles include at least one type of metal, such as iron, aluminum, copper, zinc, or a combination thereof. In some cases, the metal(s) include at least one type of ZVM. In some examples, the particles include at least one metal oxyhydroxide. In some instances, the entity flows the aqueous solution and the particles through a fluidic circuit, which may include a serpentine tube. According to some cases, the particles are generated by mixing a reducing agent with at least one type of metal salt. The reducing agent includes, for instance, at least one of uric acid, urea, tartaric acid, maleic acid, or tannic acid. In some cases, the reducing agent includes a tea extract. In some examples, desalination media has an acidic pH, such as a pH in a range of 2.5 to 5.0. The salt-media aggregates are formed when the particles bind to the salt (e.g., one or more solutes in the salt) within the mixture.

In various cases, the entity introduces the desalination media to the aqueous solution, or vice versa. In some cases, the entity mixes the desalination media with the aqueous solution. A mass-to-volume ratio of the particles in the desalination media may be in a range of 1 g/L to 50 g/L, such as a range of 10 g/L to 25 g/L. The desalination media, for instance, is added to the aqueous solution such that a ratio of a mass of the particles in the desalination media to the volume of the aqueous solution is in a range of 0.04 g/L to 0.50 g/L. In some cases, the desalination media is added to the aqueous solution such that a ratio of the mass of the particles in the desalination media to the salinity of the aqueous solution is in a range of 0.1 g/(mS/cm) to 0.5 g/(mS/cm).

At 506, the entity injects a gas into the mixture, thereby causing the salt-media aggregates to float to a surface of the mixture. For instance, the gas may be injected into a serpentine tube and/or a floatation tank that is included in a fluid circuit containing the mixture. In some implementations, the gas is an oxidizing gas. The oxidizing gas, for instance, includes at least one of air, oxygen, or ozone. In some implementations, the gas is a non-oxidizing gas, such as nitrogen and/or carbon dioxide. In particular cases, the entity injects the gas into the mixture at a rate of 10 L/min to 80.0 L/min. In various cases, the mixture has a basic pH. For instance, the pH of the mixture is in a range of 7.5 to 12.0. Optionally, the entity adds a buffer to the mixture in order to achieve the basic pH. For instance, the buffer includes a hydroxide (calcium hydroxide and/or magnesium hydroxide) and/or bicarbonate.

In various cases, the injected gas creates bubbles within the mixture. The bubbles may spontaneously adhere to the salt-media aggregates (and, optionally, other contaminants within the mixture). The bubbles also carry the salt-media aggregates (and other contaminants) to the surface of the mixture by spontaneously rising to the surface of the mixture. In various cases, a blanket including the salt-media aggregates (and other contaminants) is formed on the surface of the mixture.

At 508, the entity removes the blanket including the salt-media aggregates from the mixture. For instance, the entity may use a skimmer to move the blanket into a waste outlet. By removing the blanket, at least a portion of the salt-media aggregates are removed from the mixture, leaving behind purified water. In various cases, the removal of the salt-media aggregates results in a removal of at least 75% (or at least 80%) of the salt originally included in the aqueous solution. Optionally, the purified water is further processed using an RO device, which may remove an additional portion of the salt (e.g., up to 25% of the salt originally included in the aqueous solution, such as at least 1% of the salt originally included in the aqueous solution) from the mixture. A concentrate produced by the RO device, for instance, can be fed back into the fluid circuit, in some examples.

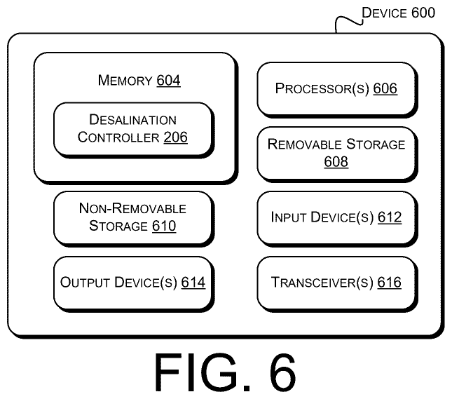

FIG. 6 illustrates at least one example device 600 configured to enable and/or perform various functionality discussed herein. Further, the device(s) 600 can be implemented as one or more server computers, a network element on a dedicated hardware, as a software instance running on a dedicated hardware, or as a virtualized function instantiated on an appropriate platform, such as a cloud infrastructure, and the like. It is to be understood in the context of this disclosure that the device(s) 600 can be implemented as a single device or as a plurality of devices with components and data distributed among them.

As illustrated, the device(s) 600 comprise a memory 604. In various embodiments, the memory 604 is volatile (including a component such as Random Access Memory (RAM)), non-volatile (including a component such as Read Only Memory (ROM), flash memory, etc.) or some combination of the two.

The memory 604 may include various components, such as instructions for executing various functions of the desalination controller 206. The memory 604 can store methods, threads, processes, applications, or any other sort of executable instructions. The memory 604 can also store files and/or databases.

The memory 604 may include various instructions (e.g., instructions of the desalination controller 206), which can be executed by at least one processor 608 to perform operations. In some embodiments, the processor(s) 608 includes a Central Processing Unit (CPU), a Graphics Processing Unit (GPU), or both CPU and GPU, or other processing unit or component known in the art.

The device(s) 600 can also include additional data storage devices (removable and/or non-removable) such as, for example, magnetic disks, optical disks, or tape. Such additional storage is illustrated in FIG. 6 by removable storage 610 and non-removable storage 612. Tangible computer-readable media can include volatile and nonvolatile, removable and non-removable media implemented in any method or technology for storage of information, such as computer readable instructions, data structures, program modules, or other data. The memory 604, removable storage 610, and non-removable storage 612 are all examples of computer-readable storage media. Computer-readable storage media include, but are not limited to, RAM, ROM, EEPROM, flash memory or other memory technology, CD-ROM, Digital Versatile Discs (DVDs), Content-Addressable Memory (CAM), or other optical storage, magnetic cassettes, magnetic tape, magnetic disk storage or other magnetic storage devices, or any other medium which can be used to store the desired information and which can be accessed by the device(s) 600. Any such tangible computer-readable media can be part of the device(s) 600.

The device(s) 600 also can include input device(s) 614, such as a keypad, a cursor control, a touch-sensitive display, voice input device, one or more sensors, and the like. In various cases, the device(s) 600 include output device(s) 616 such as a display, speakers, printers, one or more active elements (e.g., pumps, valves, heaters, etc.), and the like. In particular implementations, a user can provide input to the device(s) 600 via a user interface associated with the input device(s) 614 and/or the output device(s) 616.

As illustrated in FIG. 6, the device(s) 600 can also include one or more wired or wireless transceiver(s) 618. For example, the transceiver(s) 618 can include a Network Interface Card (NIC), a network adapter, a LAN adapter, or a physical, virtual, or logical address to connect to the various base stations or networks contemplated herein, for example, or the various user devices and servers. To increase throughput when exchanging wireless data, the transceiver(s) 618 can utilize Multiple-Input/Multiple-Output (MIMO) technology. The transceiver(s) 618 can include any sort of wireless transceivers capable of engaging in wireless, Radio Frequency (RF) communication. The transceiver(s) 618 can also include other wireless modems, such as a modem for engaging in Wi-Fi, WiMAX, Bluetooth, or infrared communication. In some implementations, the transceiver(s) 618 can be used to communicate between various functions, components, modules, or the like, that are comprised in the device(s) 600.

### EXAMPLE CLAUSES

The following Clauses provide various examples of the present disclosure. However, implementations of the present disclosure are not limited to the Clauses listed herein.
1. A desalinating dissolved gas floatation (DGF) system, including: a serpentine tube configured to receive an aqueous solution including water, sodium ions, and chloride ions; a desalination media source configured to generate a mixture in the serpentine tube by outputting a desalination media into the aqueous solution, the desalination media including iron particles configured to bind to the sodium ions and the chloride ions, thereby generating salt-media aggregates in the mixture; an aeration system configured to generate bubbles in the mixture by injecting a gas into the serpentine tube, the bubbles being configured to adhere to the salt-media aggregates in the mixture; a floatation tank fluidically coupled with the serpentine tube and configured to receive the mixture from the serpentine tube, the bubbles generating a blanket including the salt-media aggregates on a surface of the mixture in the floatation tank by rising to the surface of the mixture in the floatation tank; and a skimmer configured to move the blanket into an outlet of the floatation tank.
2. The desalinating DGF system of clause 1, wherein the aqueous solution further includes a hydrocarbon, and wherein the blanket further includes the hydrocarbon.
3 The desalinating DGF system of clause 1 or 2, further including: a sedimentation system configured to output a coagulant into the aqueous solution or the mixture; and a clarification system configured to output a flocculant into the aqueous solution or the mixture.
4. A method, including: generating a mixture by injecting a desalination media into an aqueous solution including water one or more solutes; generating salt-media aggregates in the mixture by capturing, by particles in the desalination media, the one or more solutes; generating bubbles in the mixture by injecting a gas into the mixture;
generating a blanket on a surface of the mixture by carrying, by the bubbles, the salt-media aggregates to the surface of the mixture; and removing the blanket from the mixture.
5. The method of clause 4, wherein the one or more solutes include at least one of copper ions, zinc ions, magnesium ions, manganese ions, aluminum ions, selenium ions, sodium ions, chloride ions, phosphate ions, sulfate ions, arsenic ions, nitrate ions, nitrite ions, or hypochlorite ions.
6. The method of clause 4 or 5, wherein the particles include metal nanoparticles.
7. The method of clause 6, wherein the metal nanoparticles include zero-valent iron (ZVI).
8. The method of any of clauses 4 to 7, wherein the gas includes at least one of nitrogen, air, or oxygen.
9 The method of any of clauses 4 to 8, wherein the aqueous solution further includes a hydrocarbon and/or a cell, and wherein generating the blanket on the surface of the mixture further includes carrying, by the bubbles, the hydrocarbon and/or the cell to the surface of the mixture.
10. The method of any of clauses 4 to 9, further including: generating coagulated particles in the mixture by adding, to the mixture, a coagulant, wherein generating the blanket on the surface of the mixture further includes carrying, by the bubbles, the coagulated particles to the surface of the mixture.
11. The method of any of clauses 4 to 10, further including: generating conglomerated particles in the mixture by adding, to the mixture, a flocculant, wherein generating the blanket on the surface of the mixture further includes carrying, by the bubbles, the conglomerated particles to the surface of the mixture.
12. The method of any of clauses 4 to 11, further including: flowing, by one or more pumps, the mixture through a serpentine tube.
13. A system, including: a serpentine tube configured to receive an aqueous solution including one or more solutes; a desalination media source configured to generate a mixture by outputting a desalination media into the aqueous mixture in the serpentine tube, the desalination media including particles configured to capture the one or more solutes; an aeration system configured to generate bubbles in the mixture by outputting a gas into the mixture; and a floatation tank configured to receive the mixture and to output water in the mixture omitting at least a portion of the one or more solutes, the bubbles being configured to generate a blanket on a surface of the mixture in the floatation tank by carrying salt-media aggregates including the particles and at least the portion of the one or more solutes to the surface of the mixture in the floatation tank.
14. The system of clause 13, wherein the one or more solutes include at least one of copper ions, zinc ions, magnesium ions, manganese ions, aluminum ions, selenium ions, sodium ions, chloride ions, phosphate ions, sulfate ions, arsenic ions, nitrate ions, nitrite ions, or hypochlorite ions.
15. The system of clause 13 or 14, wherein the particles include nanoparticles including one or more zero valency metals.
16. The system of any of clauses 13 to 15, wherein the gas includes nitrogen.
17. The system of any of clauses 13 to 16, wherein the mixture further includes a hydrocarbon and/or cells, and wherein the bubbles are configured to generate the blanket on the surface of the mixture in the floatation tank further by carrying the hydrocarbon and/or cells to the surface of the mixture in the floatation tank.
18. The system of any of clauses 13 to 17, further including: a sedimentation system configured to output a coagulant into the mixture; and/or a clarification system configured to output a flocculant into the mixture.
19. The system of any of clauses 13 to 18, further including: a skimmer configured to move the blanket to a waste outlet of the floatation tank.
20. The system of any of clauses 13 to 19, wherein the floatation tank is configured to output the water omitting at least the portion of the one or more solutes to the serpentine tube.

### CONCLUSION

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

What is claimed is:

1. A desalinating dissolved gas floatation (DGF) system, comprising:
a serpentine tube configured to receive an aqueous solution comprising water, sodium ions, and chloride ions;
a desalination media source configured to generate a mixture in the serpentine tube by outputting a desalination media into the aqueous solution, the desalination media comprising iron particles configured to bind to the sodium ions and the chloride ions, thereby generating salt-media aggregates in the mixture;
an aeration system configured to generate bubbles in the mixture by injecting a gas into the serpentine tube, the bubbles being configured to adhere to the salt-media aggregates in the mixture;
a floatation tank fluidically coupled with the serpentine tube and configured to receive the mixture from the serpentine tube, the bubbles generating a blanket comprising the salt-media aggregates on a surface of the mixture in the floatation tank by rising to the surface of the mixture in the floatation tank; and
a skimmer configured to move the blanket into an outlet of the floatation tank.

2. The desalinating DGF system of claim 1, wherein the aqueous solution further comprises a hydrocarbon, and
wherein the blanket further comprises the hydrocarbon.

3. The desalinating DGF system of claim 1, further comprising:
a sedimentation system configured to output a coagulant into the aqueous solution or the mixture; and
a clarification system configured to output a flocculant into the aqueous solution or the mixture.

4. A method, comprising:
generating a mixture by injecting a desalination media into an aqueous solution comprising water one or more solutes;
generating salt-media aggregates in the mixture by capturing, by particles in the desalination media, the one or more solutes;
generating bubbles in the mixture by injecting a gas into the mixture;
generating a blanket on a surface of the mixture by carrying, by the bubbles, the salt-media aggregates to the surface of the mixture; and
removing the blanket from the mixture.

5. The method of claim 4, wherein the one or more solutes comprise at least one of copper ions, zinc ions, magnesium ions, manganese ions, aluminum ions, selenium ions, sodium ions, chloride ions, phosphate ions, sulfate ions, arsenic ions, nitrate ions, nitrite ions, or hypochlorite ions.

6. The method of claim 4, wherein the particles comprise metal nanoparticles.

7. The method of claim 6, wherein the metal nanoparticles comprise zero-valent iron (ZVI).

8. The method of claim 4, wherein the gas comprises at least one of nitrogen, air, or oxygen.

9. The method of claim 4, wherein the aqueous solution further comprises a hydrocarbon and/or a cell, and
wherein generating the blanket on the surface of the mixture further comprises carrying, by the bubbles, the hydrocarbon and/or the cell to the surface of the mixture.

10. The method of claim 4, further comprising:
generating coagulated particles in the mixture by adding, to the mixture, a coagulant,
wherein generating the blanket on the surface of the mixture further comprises carrying, by the bubbles, the coagulated particles to the surface of the mixture.

11. The method of claim 4, further comprising:
generating conglomerated particles in the mixture by adding, to the mixture, a flocculant,
wherein generating the blanket on the surface of the mixture further comprises carrying, by the bubbles, the conglomerated particles to the surface of the mixture.

12. The method of claim 4, further comprising:
flowing, by one or more pumps, the mixture through a serpentine tube.

13. A system, comprising:
a serpentine tube configured to receive an aqueous solution comprising one or more solutes;
a desalination media source configured to generate a mixture by outputting a desalination media into the aqueous mixture in the serpentine tube, the desalination media comprising particles configured to capture the one or more solutes;
an aeration system configured to generate bubbles in the mixture by outputting a gas into the mixture; and
a floatation tank configured to receive the mixture and to output water in the mixture omitting at least a portion of the one or more solutes, the bubbles being configured to generate a blanket on a surface of the mixture in the floatation tank by carrying salt-media aggregates comprising the particles and at least the portion of the one or more solutes to the surface of the mixture in the floatation tank.

14. The system of claim 13, wherein the one or more solutes comprise at least one of copper ions, zinc ions, magnesium ions, manganese ions, aluminum ions, selenium ions, sodium ions, chloride ions, phosphate ions, sulfate ions, arsenic ions, nitrate ions, nitrite ions, or hypochlorite ions.

15. The system of claim 13, wherein the particles comprise nanoparticles comprising one or more zero valency metals.

16. The system of claim 13, wherein the gas comprises nitrogen.

17. The system of claim 13, wherein the mixture further comprises a hydrocarbon and/or cells, and
wherein the bubbles are configured to generate the blanket on the surface of the mixture in the floatation tank further by carrying the hydrocarbon and/or cells to the surface of the mixture in the floatation tank.

18. The system of claim 13, further comprising:
a sedimentation system configured to output a coagulant into the mixture; and/or
a clarification system configured to output a flocculant into the mixture.

19. The system of claim 13, further comprising:
a skimmer configured to move the blanket to a waste outlet of the floatation tank.

20. The system of claim 13, wherein the floatation tank is configured to output the water omitting at least the portion of the one or more solutes to the serpentine tube.
